(19) United States
(12) Patent Application Publication
(10) Pub. No.: US 2023/0261400 A1
(43) Pub. Date: Aug. 17, 2023

(54) CONNECTOR AND ELECTRONIC APPARATUS

(71) Applicant: KYOCERA CORPORATION, Kyoto (JP)

(72) Inventor: Akio TSUNEMURA, Machida-shi, Tokyo (JP)

(21) Appl. No.: 18/015,273

(22) PCT Filed: Jul. 6, 2021
(86) PCT No.: PCT/JP2021/025520

§ 371 Date: Jan. 9, 2023

(30) Foreign Application Priority Data
Jul. 9, 2020 (JP) 2020-118806

(51) Int. Cl. H01R 12/71; H01R 12/57; H01R 13/405

(52) U.S. Cl. CPC H01R 12/716; H01R 12/57; H01R 13/405; H01R 12/714

(57) ABSTRACT

According to the present disclosure, a connector (1) includes a first connector (10) and a second connector (50) to connect each other. The first connector (10) includes an insulator (20), a first metal fitting (40a), and a second metal fitting (40b). The insulator (20) includes a protrusion (22) and an outside wall (23) surrounding the protrusion (22). The first metal fitting (40a) includes a second base portion (43a) extending in a longitudinal direction of the first connector (10) and a mount portion (45a) to be mounted onto a circuit substrate (CB1). The first metal fitting (40a) and the second metal fitting (40b) are separate members and are attached to the protrusion (22) and the outside wall (23), respectively. The mount portion (45a) includes a bottom surface of the second base portion (43a), the bottom surface facing the circuit substrate (CB1).

### CROSS-REFERENCE TO RELATED APPLICATIONS

This application claims the benefit of Japanese Patent Application No. 2020-118806 filed Jul. 9, 2020, which is hereby incorporated by reference herein in its entirety.

### TECHNICAL FIELD

The present disclosure relates to a connector and an electronic apparatus.

### BACKGROUND OF INVENTION

An art of a connector including a first connector and a second connector is known widely. The first connector and the second connector are mounted on respective separate circuit substrates, and the connector electrically connects the separate circuit substrates to each other. For example, Patent Literature 1 discloses an electric connector for circuit substrate. The electric connector for circuit substrate can prevent both a projecting wall and end walls from breaking during connection and disconnection of the connector.

Electronic apparatuses, such as mobile devices, have been subjected to weight and size reduction in recent years, and connectors mounted in the electronic apparatuses are also subjected to a reduction in size and height.

### CITATION LIST

### Patent Literature

Patent Literature 1: Japanese Unexamined Patent Application Publication No. 2018-170296

### SUMMARY

In an embodiment of the present disclosure, a connector includes a first connector and a second connector to connect each other. The first connector includes an insulator, a first metal fitting, and a second metal fitting. The insulator includes a protrusion and an outside wall surrounding the protrusion. The first metal fitting includes a second base portion extending in a longitudinal direction of the first connector and a mount portion to be mounted onto a circuit substrate. The first metal fitting is attached to the protrusion. The second metal fitting is attached to the outside wall. The first metal fitting and the second metal fitting are separate members. The mount portion includes a bottom surface of the second base portion, the bottom surface facing the circuit substrate.

In an embodiment of the present disclosure, an electronic apparatus includes the above connector.

### BRIEF DESCRIPTION OF DRAWINGS

FIG. 1 is a perspective view, as viewed from above, illustrating the exterior of a connector according to an embodiment, the connector being in a state in which a first connector and a second connector are connected to each other.

FIG. 2 is a perspective view, as viewed from above, illustrating the exterior of the connector according to the embodiment, the connector being in a state in which the first connector and the second connector are separated from each other.

FIG. 3 is a perspective view, as viewed from above, illustrating the exterior of the first connector of FIG. 1.

FIG. 4 is an exploded perspective view, as viewed from above, illustrating the first connector of FIG. 3.

FIG. 5 is an enlarged view illustrating a region surrounded by the dash-dot line in FIG. 3.

FIG. 6 is an enlarged view illustrating the first connector of FIG. 5 as viewed from below.

FIG. 7 is a perspective view, as viewed from above, illustrating the exterior of the second connector of FIG. 1.

FIG. 8 is a cross-sectional view of the connector taken along line VIII-VIII in FIG. 1.

FIG. 9 is a cross-sectional view of the connector taken along line IX-IX in FIG. 1.

FIG. 10 is a cross-sectional view of the connector taken along line X-X in FIG. 1.

FIG. 11 is an enlarged view illustrating a variation of the first connector of the embodiment, the view corresponding to FIG. 5.

FIG. 12 is an enlarged view illustrating a second variation of the first connector of the embodiment, the view corresponding to FIG. 6.

FIG. 13 is a cross-sectional view illustrating the second variation of the first connector of the embodiment, the view corresponding to FIG. 9.

### DESCRIPTION OF EMBODIMENTS

A first connector is subjected to size and height reduction, and components of the first connector, such as metal fittings or an insulator, tend to be broken easily when the first connector hits a second connector during the engagement of these connectors. In the electric connector for circuit substrate disclosed in Patent Literature 1, for example, a metal fitting to be attached to a protruding wall and a metal fitting to be attached to an end wall are integrally formed as one piece. In this case, if the second connector hits and breaks a portion of the metal fitting at the end wall or at the protruding wall, the breakage may affect the other portion of the metal fitting especially in the case of the first connector being reduced in size and height. This tends to increase the scale of damage of the metal fitting or of the insulator.

According to an embodiment of the present disclosure, the connector and the electronic apparatus improve in robustness during and after the engagement of the first connector and the second connector even in the case of the connector being reduced in size and height.

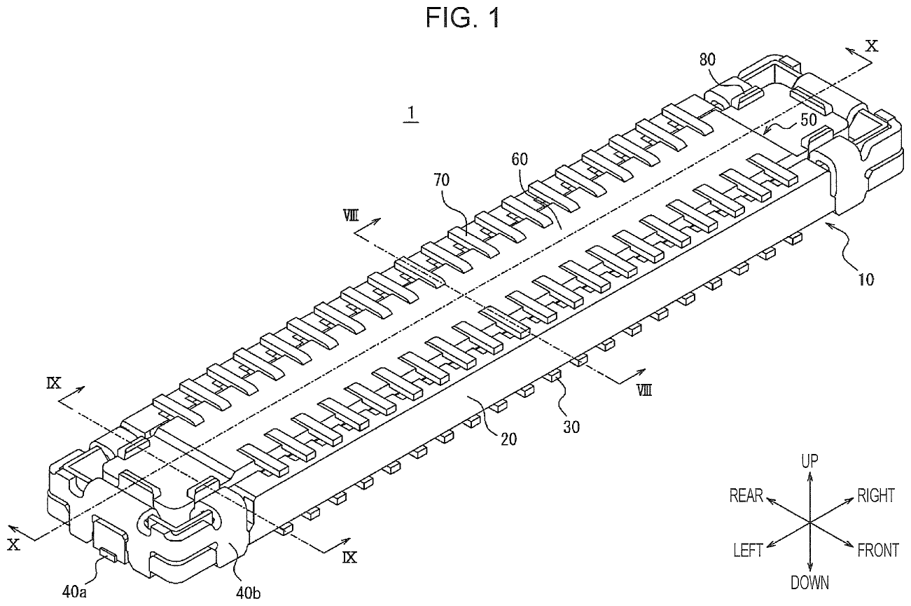

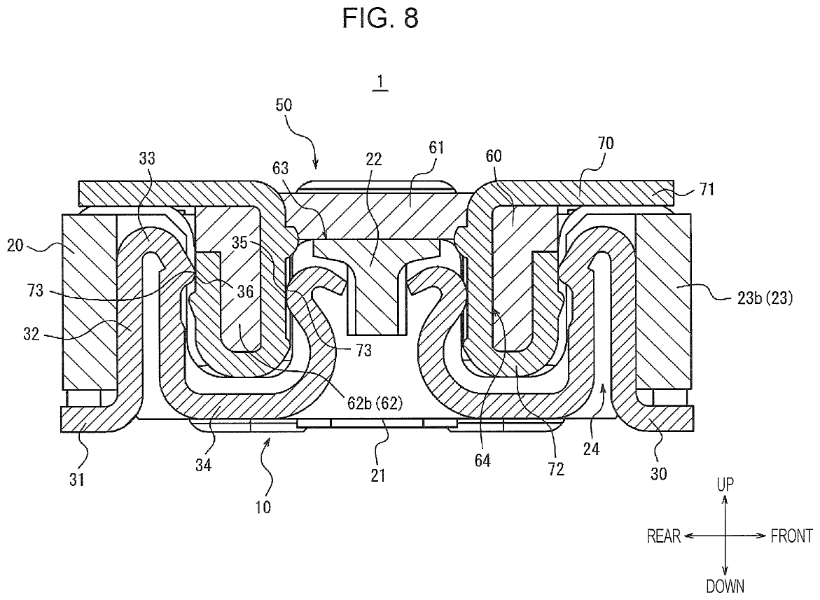

The following describes an embodiment of the present disclosure in detail with reference to the drawings. In the following description, the front-rear direction, the right-left direction, and the up-down direction are defined with reference to the directions of arrows in the drawings. The directions of arrows in FIGS. 1 to 6 and in FIGS. 8 to 11 are aligned each other with corresponding arrows in different figures. In some drawings, circuit substrates CB1 and CB2 (to be described later) are omitted to facilitate easy understanding.

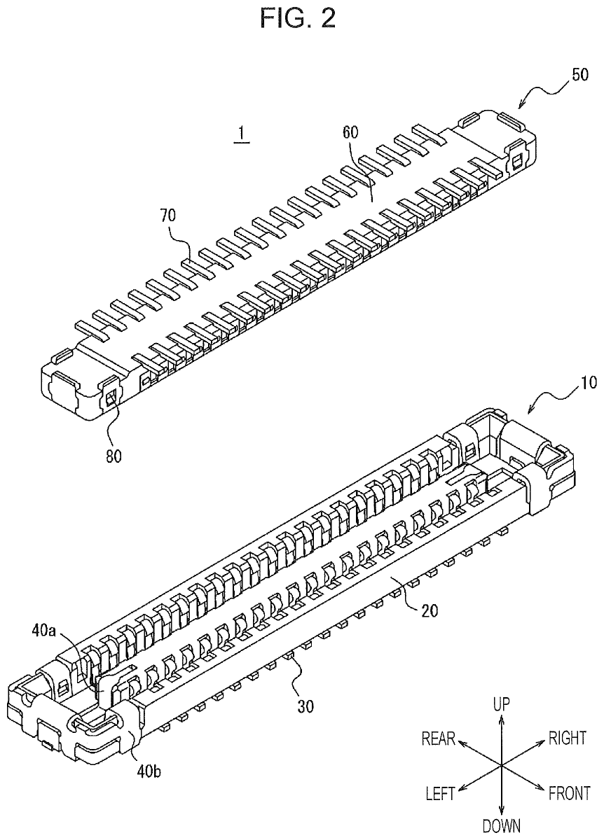

FIG. 1 is a perspective view, as viewed from above, illustrating the exterior of a connector 1 according to an embodiment, in which a first connector 10 and a second connector 50 are connected to each other. FIG. 2 is a perspective view, as viewed from above, illustrating the exterior of the connector 1 according to the embodiment, in which the first connector 10 and the second connector 50 are separated from each other.

For example, as illustrated in FIG. 2, the connector 1 includes the first connector 10 and the second connector 50 that can be connected to each other. The first connector 10 includes a first insulator 20 and first contacts 30 attached to the first insulator 20. The first connector 10 also includes first metal fittings 40a and second metal fittings 40b, and these fittings are attached to the first insulator 20.

The second connector 50 is connectable to the first connector 10. The second connector 50 includes a second insulator 60. The second insulator 60 connects the first insulator 20 when the first connector 10 and the second connector 50 are connected to each other. The second connector 50 also includes second contacts 70 attached to the second insulator 60. The second contacts 70 are in contact with respective first contacts 30 in an engagement state in which the first insulator 20 connects the second insulator 60. The second connector 50 further includes metal fittings 80 attached to the second insulator 60.

In the following description, the first connector 10 of the embodiment is assumed to be a receptacle connector by way of example. The second connector 50 is assumed to be a plug connector. The first connector 10 is assumed to be the receptacle connector in which the first contacts 30 are deformed elastically in the engagement state in which the first insulator 20 and the second insulator 60 connect each other. The second connector 50 is assumed to be the plug connector in which the second contacts 70 are not deformed elastically. The types of the first connector 10 and the second connector 50 are not limited to those described above. For example, the first connector 10 may serve as the plug connector, and the second connector 50 may serve as the receptacle connector.

In the following description, the first connector 10 and the second connector 50 are assumedly mounted on circuit substrates CB1 and CB2, respectively. The circuit substrate CB1 and the circuit substrate CB2 are electrically coupled to each other in the connection state in which the first connector 10 and the second connector 50 are connected to each other. The circuit substrates CB1 and CB2 may be rigid substrates or may be any arbitrary substrates other than the rigid substrates. For example, at least one of the circuit substrates CB1 and CB2 may be a flexible printed circuit substrate.

In the following description, the first connector 10 and the second connector 50 are assumedly connected to respective circuit substrates CB1 and CB2 in the vertical direction. The first connector 10 and the second connector 50 are connected to each other, for example, in the up-down direction. The direction of connection is not limited to the up-down direction. The first connector 10 and the second connector 50 may be connected to respective circuit substrates CB1 and CB2 in the horizontal direction. The first connector 10 and the second connector 50 may be connected each other in such a manner that one of the first connector 10 and the second connector 50 is positioned vertically relative to the circuit substrate to which the one is mounted and the other is positioned horizontally relative to the circuit substrate to which the other one is mounted.

For example, the term “longitudinal direction of the connector”, as used in the claims, corresponds to the right-left direction. For example, the term “arrangement direction” corresponds to the right-left direction. For example, the term “transverse direction of the connector” corresponds to the front-rear direction.

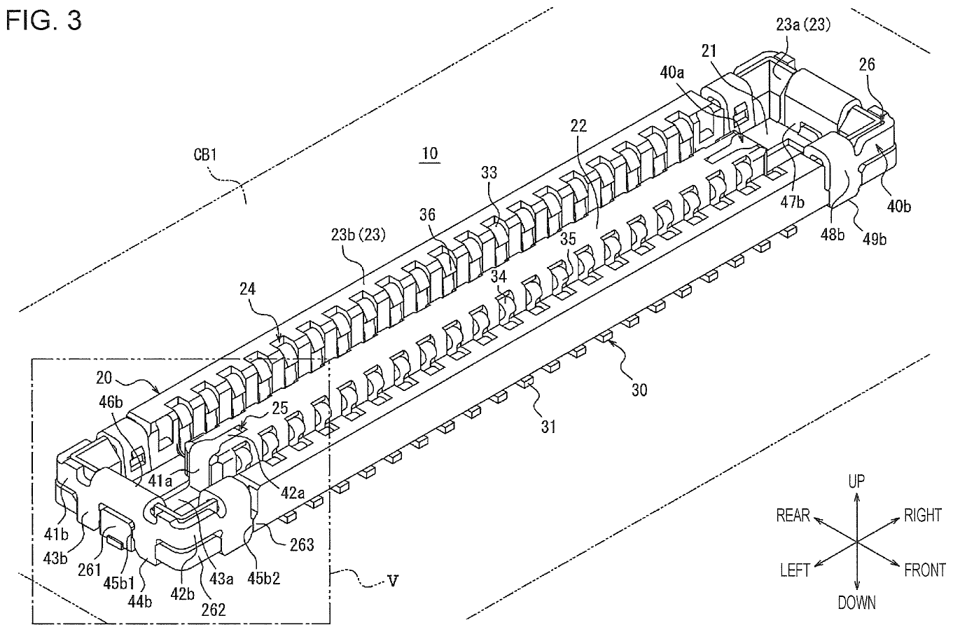

FIG. 3 is a perspective view, as viewed from above, illustrating the exterior of the first connector 10 of FIG. 1. For example, the first connector 10 can be obtained in the following manner: the first insulator 20 is formed integrally with the first metal fittings 40a using insert molding, and the first contacts 30 and the second metal fittings 40b are press-fitted into the first insulator 20.

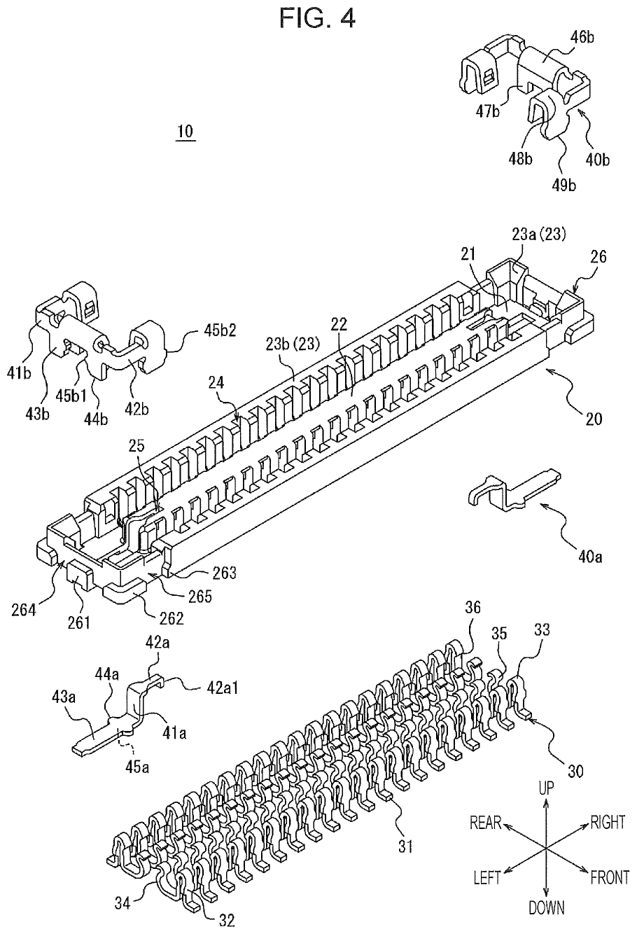

FIG. 4 is an exploded perspective view, as viewed from above, illustrating the first connector 10 of FIG. 3. Although the first insulator 20 and the first metal fittings 40a are formed integrally by insert molding, the first metal fittings 40a and the first insulator 20 are illustrated separately in FIG. 4 to facilitate easy understanding.

The first insulator 20 of the first connector 10 is made of a synthetic resin having insulating and heat-resisting properties. The first insulator 20 is shaped like a plate elongated in the right-left direction. The first insulator 20 includes a bottom plate 21 that constitutes the bottom part the first insulator 20. The first insulator 20 includes a protrusion 22 that projects upward from the bottom plate 21 at a central portion of the bottom plate 21 in the front-rear direction and in the right-left direction. The first insulator 20 includes outside walls 23 that surround the protrusion 22. The outside walls 23 surrounds the protrusion 22 in four directions, in other words, in the front-rear direction and in the right-left direction. The outside walls 23 include transverse walls 23a and longitudinal walls 23b. The transverse walls 23a extend in the front-rear direction. The longitudinal walls 23b extend in the right-left direction.

The first insulator 20 includes first-contact mounting grooves 24. Each first-contact mounting groove 24 is formed continuously in the front-rear direction along an inside surface of a longitudinal wall 23b, the bottom plate 21, and an inside surface of the protrusion 22. A first contact 30 is mounted in each first-contact mounting groove 24. Multiple first-contact mounting grooves 24 are formed, and the number of the first-contact mounting grooves 24 corresponds to the number of the first contacts 30. The first-contact mounting grooves 24 are arranged in the arrangement direction of the first contacts 30.

The first insulator 20 includes first-metal-fitting holding portions 25. Each of the first-metal-fitting holding portions 25 extends from one end of the protrusion 22 in the right-left direction through part of the bottom plate 21 to the bottom surface of a corresponding transverse wall 23a. A first metal fitting 40a is attached to the first-metal-fitting holding portion 25. The first-metal-fitting holding portion 25 extends in the right-left direction so as to connect the protrusion 22 and the transverse wall 23a.

The first insulator 20 includes second-metal-fitting mounting portions 26. Each second-metal-fitting mounting portion 26 is formed continuously along the transverse wall 23a and also along corresponding end portions of the longitudinal walls 23b, the end portions being positioned in the right-left direction. A second metal fitting 40b is attached to each second-metal-fitting mounting portion 26.

Each second-metal-fitting mounting portion 26 includes a first wall portion 261. The first wall portion 261 is formed at a lower position in a central portion of each transverse wall 23a in the front-rear direction, and the first wall portion 261 protrudes outward in the right-left direction. The second-metal-fitting mounting portion 26 includes second wall portions 262. The second wall portions 262 are formed at respective corner portions of the first insulator 20. More specifically, each second wall portion 262 is formed at a lower position in each corner portion of the first insulator 20 so as to have a shape like the letter L along the transverse wall 23a and the longitudinal wall 23b. The second-metal-fitting mounting portion 26 includes third wall portions 263. The third wall portions 263 are formed at respective longitudinal walls 23b so as to be separated from corresponding second wall portions 262 in the right-left direction. The first wall portions 261, the second wall portions 262, and the third wall portions 263 form rectangular outermost shapes of the first insulator 20 in the front-rear direction and in the right-left direction.

Each second-metal-fitting mounting portion 26 also includes first mounting grooves 264 that are formed between the first wall portion 261 and respective second wall portions 262. Each second-metal-fitting mounting portion 26 also includes second mounting grooves 265 that are formed between respective second wall portions 262 and the corresponding third wall portions 263.

Each first contact 30 is formed, for example, of a thin plate that has a spring-like elasticity and is made of a copper alloy, such as phosphor bronze, beryllium copper, or copper-titanium alloy, or of a Corson system copper alloy. The first contact 30 is formed of the thin plate so as to have a shape illustrated in FIG. 4 using progressive metal forming (stamping). The surface of the first contact 30 is plated with nickel to form a foundation layer and further plated with gold or tin thereover.

The first contact 30 includes a mount portion 31 that is an L-shaped protrusion protruding outward in the front-rear direction. The first contact 30 also includes a locking portion 32 that extends upward from the top end of the mount portion 31. The locking portion 32 is formed so as to be wider in the right-left direction than the mount portion 31. The first contact 30 includes a curved portion 33 shaped like the letter U. The curved portion 33 protrudes upward from the locking portion 32.

The first contact 30 includes an elastic contact arm 34 that continues to the curved portion 33 and is shaped like the letter S. The first contact 30 includes an elastic contact point 35. The electric contact point 35 is faulted at the bent end portion of the elastic contact arm 34. The electric contact point 35 faces outward in the front-rear direction. The first contact 30 also includes a contact point 36 formed at the curved portion 33. The contact point 36 protrudes so as to oppose the elastic contact point 35 in the front-rear direction.

Each first metal fitting 40a is formed of a thin plate of an arbitrary metal so as to have a shape illustrated in FIG. 4 using progressive metal forming (stamping). The first metal fitting 40a as a whole has a crank-like shape. More specifically, the first metal fitting 40a is formed of a hook portion 42a, a first base portion 41a, and a second base portion 43a (to be described later), and these portions integrally form the crank-like shape as a whole. The method of manufacturing the first metal fitting 40a includes a step of punching out a piece and a step of bending the punched piece in the thickness direction. The method of manufacturing the first metal fitting 40a is not limited to this but may include the step of punching only.

The first metal fitting 40a includes the first base portion 41a. The first base portion 41a is shaped like the letter L. For example, the first base portion 41a extends in the up-down direction, and the first base portion 41a is bent at the top end thereof toward one side in the right-left direction. The first base portion 41a connects the second base portion 43a and the hook portion 42a (to be described later).

The first metal fitting 40a includes the hook portion 42a. The first base portion 41a has the portion that extends toward the above-described one side in the right-left direction, and the hook portion 42a extends further toward the one side from the portion of the first base portion 41a. The hook portion 42a is shaped like the letter L. The hook portion 42a has a tip end 42a1, and the tip end 42a1 is, for example, bent downward from the end of the hook portion 42a. The width of the hook portion 42a in the front-rear direction is smaller than the width of any other portion of the first metal fitting 40a. In other words, the width of the hook portion 42a in the front-rear direction is smaller, for example, than the width of the first base portion 41a that continues to the hook portion 42a. The width of the hook portion 42a in the front-rear direction is smaller, for example, than the width of the second base portion 43a or the width of a wide portion 44a (to be described later).

The first metal fitting 40a includes the second base portion 43a that extends straight toward the other side in the right-left direction from the bottom end of the first base portion 41a. The width of the second base portion 43a in the front-rear direction is the same as or similar to the width of the first base portion 41a that continues to the second base portion 43a.

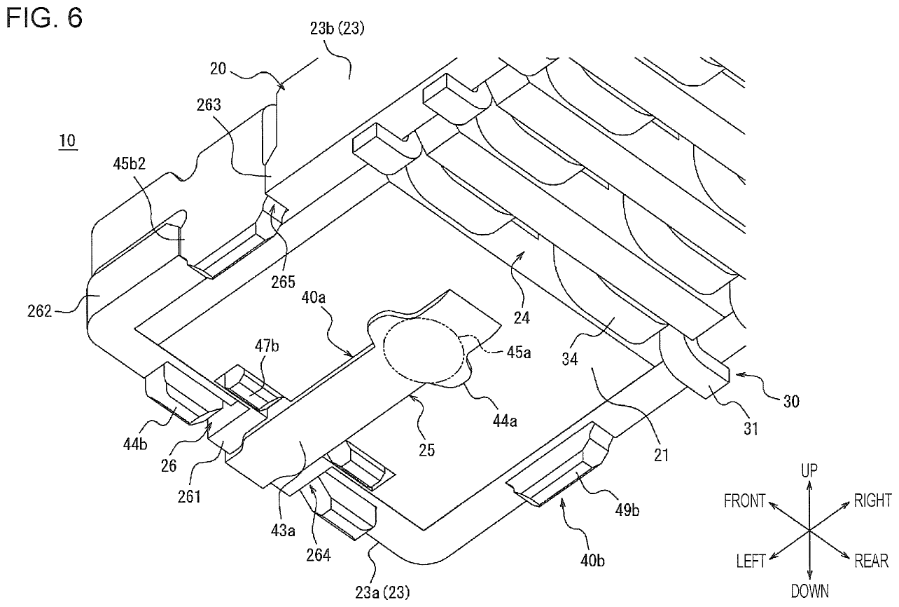

The first metal fitting 40a includes a wide portion 44a in the second base portion 43a. The wide portion 44a is formed so as to be wider than any other portion of the second base portion 43a in the front-rear direction. The wide portion 44a has symmetrically shaped protrusions that protrude from the second base portion 43a in the front-rear direction. As illustrated in FIG. 6 (to be described later), the first metal fitting 40a includes a mount portion 45a. For example, the mount portion 45a includes a predefined region on the bottom surface of the second base portion 43a. The mount portion 45a, however, is not limited to the region surrounded by the dash-dot-dot line on the bottom surface of the second base portion 43a. In addition to this region, the mount portion 45a may further include the bottom surface of the wide portion 44a and side surfaces of the wide portion 44a that extend in the up-down direction. The mount portion 45a is formed in the second base portion 43a at a position substantially same as that of the wide portion 44a in the right-left direction.

Each second metal fitting 40b is formed of a thin plate of an arbitrary metal so as to have a shape illustrated in FIG. 4 using progressive metal forming (stamping). The method of manufacturing the second metal fitting 40b includes a step of punching out a piece and a step of bending the punched piece in the thickness direction.

The second metal fitting 40b includes a first base portion 41b that extends in the front-rear direction. The second metal fitting 40b also includes second base portions 42b that protrude toward the above-described one side in the right-left direction from respective ends of the first base portion 41b in the front-rear direction. The second metal fitting 40b includes protruding portions 43b that protrude straight downward from respective front and rear portions of the first base portion 41b. A pair of the protruding portions 43b, which are separated in the front-rear direction, have respective edges that oppose each other. These edges of the protruding portions 43b and a lower edge of the first base portion 41b form a recess. The second metal fitting 40b includes first mount portions 44b positioned at respective bottom ends of the protruding portions 43b. The second metal fitting 40b includes locking portions 45b1 formed at respective protruding portions 43b. The locking portions 45b1 are formed so as to be wider in the front-rear direction than any other portion of the protruding portions 43b. The locking portions 45b1 protrude inward into the recess so as to reduce the width of the recess in the front-rear direction.

The second metal fitting 40b includes a curved portion 46b that is shaped like the letter U. The curved portion 46b is formed so as to protrude toward the one side in the right-left direction from a portion of the first base portion 41b at the center in the front-rear direction. The second metal fitting 40b includes second mount portions 47b that protrude straight downward from respective bottom ends of front and rear portions of the curved portion 46b.

The second metal fitting 40b includes contact arms 48b each shaped like the letter U. The contact arms 48b extend toward the one side in the right-left direction from respective ends of the second base portions 42b. Each contact arm 48b has a portion extending inward in the front-rear direction, and the portion has a spring-like elasticity. The second metal fitting 40b includes third mount portions 49b positioned at bottom ends of outside portions of respective contact arms 48b, the outside portions facing outward in the front-rear direction. The second metal fitting 40b includes locking portions 45b2 adjoining respective top ends of the third mount portions 49b. Each locking portion 45b2 is formed so as to be wider in the right-left direction than any other portion of the contact arms 48b. The locking portion 45b2 has symmetrically shaped protrusions that protrudes from each contact arm 48b in the right-left direction.

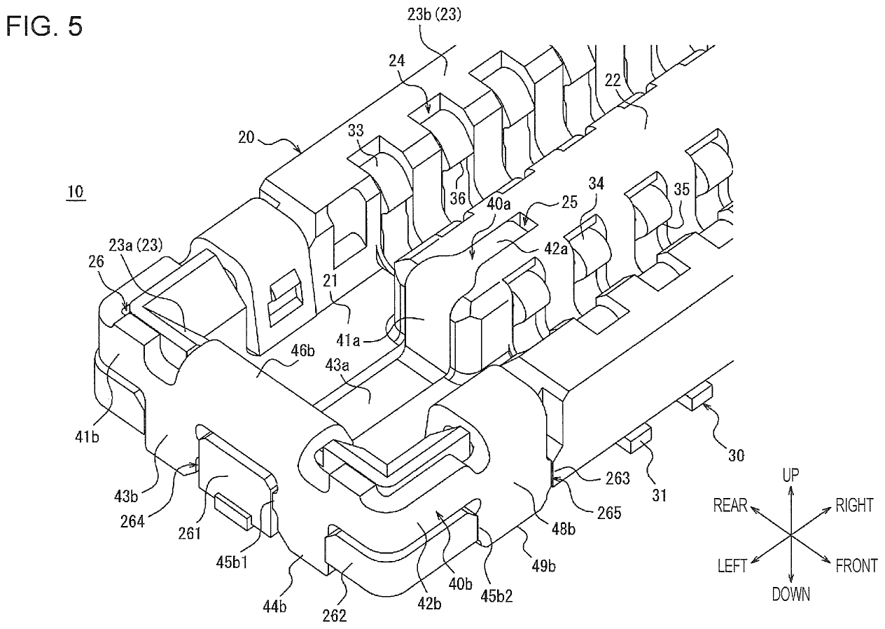

FIG. 5 is an enlarged view illustrating region V surrounded by the dash-dot line in FIG. 3. FIG. 6 is an enlarged view illustrating the first connector 10 of FIG. 5 as viewed from below.

Each first contact 30 is press-fitted into the first insulator 20 from below. In this state, the locking portion 32 is locked between inside surfaces of each first-contact mounting groove 24, the inside surfaces facing each other in the right-left direction. The first contact 30 is thereby held in the first-contact mounting groove 24.

When the first contact 30 is held in the corresponding first-contact mounting groove 24 of the first insulator 20, the elastic contact point 35 and the contact point 36 project from the first-contact mounting groove 24 into the space between the protrusion 22 and the corresponding longitudinal wall 23b. In this state, the elastic contact arm 34 is elastically deformable in the front-rear direction inside the first-contact mounting groove 24. The tip end of the mount portion 31 is positioned outside the longitudinal wall 23b in the front-rear direction.

As illustrated in FIGS. 5 and 6, the first metal fitting 40a and the second metal fitting 40b are separate members.

Each first metal fitting 40a is attached to the protrusion 22. The first metal fitting 40a extends in the longitudinal direction of the first connector 10 from the protrusion 22 to the corresponding transverse wall 23a to which a second metal fitting 40b is attached.

For example, each first metal fitting 40a is formed integrally in the corresponding first-metal-fitting holding portion 25 of the first insulator 20 using insert molding. Here, the first base portion 41a is integrated into an end portion of the protrusion 22, at an end in the right-left direction, over the top surface and the side surface of the end portion. The side surface of the first base portion 41a facing outward in the right-left direction and the top surface of the first base portion 41a are exposed from the first insulator 20. For example, the top surface of the first base portion 41a is flush with the top surface of the protrusion 22. For example, the side surface of the first base portion 41a facing outward in the right-left direction is flush with the corresponding side surface of the protrusion 22. The top and side surfaces of the first base portion 41a, however, are not limited to the above. The top surface of the first base portion 41a may be disposed below the top surface of the protrusion 22. The side surface of the first base portion 41a may be positioned further inside from the side surface of the protrusion 22 in the right-left direction.

The hook portion 42a is formed integrally in the protrusion 22 at the top surface thereof in such a manner that the tip end 42a1 of the hook portion 42a is embedded in the protrusion 22. The top surface of the hook portion 42a is exposed from the first insulator 20. For example, the top surface of the hook portion 42a is flush with the top surface of the protrusion 22. The top surface of the hook portion 42a is not limited to this but may be positioned below the top surface of the protrusion 22.

The second base portion 43a is formed integrally in the bottom plate 21 and in a lower end portion of the transverse wall 23a. When the first metal fitting 40a and the first insulator 20 are formed integrally using insert molding, the second base portion 43a with the wide portion 44a is in close contact with the bottom plate 21. The second base portion 43a extends in the longitudinal direction of the first connector 10. The second base portion 43a extends from the protrusion 22 to the transverse wall 23a to which the second metal fitting 40b is attached. The top surface and the bottom surface of the second base portion 43a are exposed from the first insulator 20 at the position where the second base portion 43a is integrated with the bottom plate 21. For example, the top surface of the second base portion 43a is positioned below the top surface of the bottom plate 21. For example, the bottom surface of the second base portion 43a is positioned below the bottom surface of the bottom plate 21.

The mount portion 45a of the first metal fitting 40a to be mounted on the circuit substrate CB1 includes the bottom surface of the second base portion 43a that faces the circuit substrate CB1. For example, the mount portion 45a has a predefined area extending in the front-rear direction and in the right-left direction on the bottom surface of the second base portion 43a. The mount portion 45a is positioned between the protrusion 22 and the transverse wall 23a in the right-left direction. The mount portion 45a is formed at a position outside of, and adjacent to, the protrusion 22 in the right-left direction.

For example, each second metal fitting 40b is press-fitted into the first insulator 20 from above. Each second metal fitting 40b is attached to a corresponding one of the outside walls 23 in such a manner that the first wall portion 261 is nipped in the recess that are formed by the lower edge of the first base portion 41b and the mutually opposing edges of respective protruding portions 43b that are separated in the front-rear direction.

Here, each locking portion 45b1 is locked between the first wall portion 261 and the corresponding second wall portion 262 of the second-metal-fitting mounting portion 26 at a position outside the transverse wall 23a in the right-left direction. A pair of the protruding portions 43b separated in the front-rear direction are fitted in respective first mounting grooves 264. Similarly, each locking portion 45b2 is locked between the second wall portion 262 and the corresponding third wall portion 263 of the second-metal-fitting mounting portion 26 at a position outside the corresponding longitudinal wall 23b in the front-rear direction. A portion of each contact arm 48b that faces outward in the front-rear direction is attached in the corresponding second mounting groove 265. Thus, the second metal fitting 40b is held by the second-metal-fitting mounting portion 26.

When the second metal fitting 40b is held by the second-metal-fitting mounting portion 26 of the first insulator 20, the second metal fitting 40b covers the entire transverse wall 23a and also covers portions of the longitudinal walls 23b at ends in the right-left direction. In this state, the second metal fitting 40b surrounds the second base portion 43a of the corresponding first metal fitting 40a in both directions in the front-rear direction and from the outside in the right-left direction. More specifically, the second base portions 42b and the contact arms 48b of the second metal fitting 40b are disposed at both sides of the second base portion 43a of the first metal fitting 40a in the front-rear direction. The first base portion 41b, the protruding portions 43b, and the curved portion 46b of the second metal fitting 40b are disposed so as to superpose the outermost portion of the second base portion 43a of the first metal fitting 40a in the right-left direction. Each contact arm 48b includes a portion being positioned inside in the front-rear direction and extending downward, and this portion is elastically deformable in the front-rear direction.

The first mount portions 44b are disposed along the outside surface of the corresponding transverse wall 23a, the outside surface facing outward in the right-left direction. The first mount portions 44b protrude downward below the bottom end of the transverse wall 23a. The first mount portions 44b are positioned respectively at both sides of the second base portion 43a of the first metal fitting 40a in the transverse direction of the first connector 10. A pair of the first mount portions 44b are positioned so as to straddle the second base portion 43a of the first metal fitting 40a in the front-rear direction. For example, a pair of the first mount portions 44b are disposed respectively at symmetrical positions in the front-rear direction with respect to the second base portion 43a of the first metal fitting 40a.

The second mount portions 47b are disposed in the right-left direction along the inside surface of each transverse wall 23a. The second mount portions 47b and the first mount portions 44b are disposed so as to straddle the transverse wall 23a. The second mount portions 47b protrude downward below the bottom end of the transverse wall 23a. The second mount portions 47b protrude downward through the bottom plate 21 and are exposed therefrom. The second mount portions 47b are positioned respectively at both sides of the second base portion 43a of the first metal fitting 40a in the transverse direction of the first connector 10. A pair of the second mount portions 47b are positioned so as to straddle the second base portion 43a of the first metal fitting 40a in the front-rear direction. For example, a pair of the second mount portions 47b are disposed respectively at symmetrical positions in the front-rear direction with respect to the second base portion 43a of the first metal fitting 40a. In the front-rear direction, the distance between the second mount portions 47b is smaller than the distance between the first mount portions 44b. A pair of the second mount portions 47b are disposed respectively at positions adjacent to the second base portion 43a of the first metal fitting 40a in the front-rear direction.

The third mount portions 49b are disposed along the outside surfaces of respective longitudinal walls 23b, the outside surfaces facing outward in the front-rear direction. The third mount portions 49b protrude downward below the longitudinal walls 23b. The third mount portions 49b are positioned respectively at both sides of the first metal fitting 40a in the transverse direction of the first connector 10. A pair of the third mount portions 49b are positioned so as to straddle the second base portion 43a of the first metal fitting 40a in the front-rear direction. For example, a pair of the third mount portions 49b are disposed at symmetrical positions in the front-rear direction with respect to the mount portion 45a formed at the second base portion 43a. A pair of the third mount portions 49b are disposed substantially at the same positions as the mount portion 45a and the wide portion 44a of the first metal fitting 40a in the right-left direction.

In the first connector 10 with the above-described structure, the mount portions 31 of respective first contacts 30 are soldered to the mount surface of the circuit substrate CB1 on which a circuit pattern is formed. The mount portions 45a of respective first metal fittings 40a, and the first mount portions 44b, the second mount portions 47b, and the third mount portions 49b of respective second metal fittings 40b are soldered to the mount surface having the circuit pattern. Thus, each mount portion is mounted onto the circuit substrate CB1, and the first connector 10 is thereby mounted onto the circuit substrate CB1. For example, electronic components other than the first connector 10, such as a central processing unit (CPU), a controller, and a memory, are also mounted on the mount surface of the circuit substrate CB1.

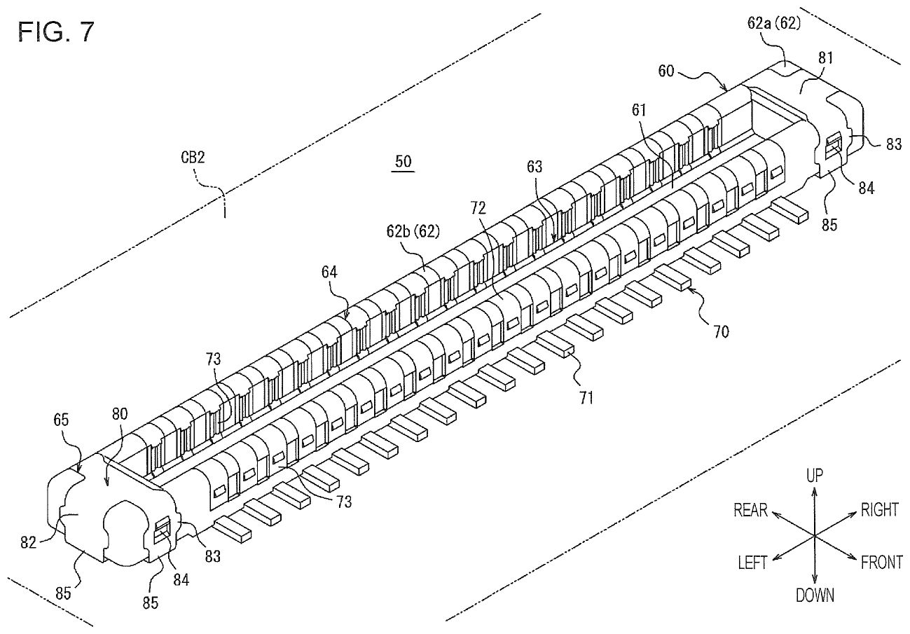

The following describes the structure of the second connector 50 with reference mainly to FIG. 7.

FIG. 7 is a perspective view illustrating the exterior of the second connector 50 of FIG. 1 as viewed from above. The second connector 50 can be obtained, for example, by forming the second insulator 60 integrally with the second contacts 70 and the metal fittings 80 using insert molding.

The second insulator 60 is a plate-like member elongated in the right-left direction. The second insulator 60 is made of a synthetic resin having insulating and heat-resisting properties using injection molding. The second insulator 60 includes a bottom plate 61 that constitutes the bottom part of the second insulator 60. The second insulator 60 includes annularly formed outside walls 62 that protrude upward from peripheral portions of the bottom plate 61, the peripheral portions extending in the front-rear and right-left directions. The outside walls 62 include transverse walls 62a and longitudinal walls 62b. The transverse walls 62a extend in the front-rear direction. The longitudinal walls 62b extend in the right-left direction. The second insulator 60 includes a recess 63 surrounded by the outside walls 62 in the front-rear direction and in the right-left direction.

The second insulator 60 includes second-contact holding portions 64 each of which is formed continuously in each longitudinal wall 62b and in the bottom plate 61. The second contacts 70 are mounted in respective second-contact holding portions 64. The second insulator 60 includes metal-fitting holding portions 65 formed in respective transverse walls 62a. The metal fittings 80 are attached to respective metal-fitting holding portion 65.

Each second contact 70 having a shape as illustrated is formed, for example, of a thin plate made of a copper alloy, such as phosphor bronze, beryllium copper, or copper-titanium alloy, or of a Corson system copper alloy, using progressive metal forming (stamping). The surface of the second contact 70 is plated with nickel to form a foundation layer and further plated with gold or tin thereover.

The second contact 70 includes a mount portion 71 that is an L-shaped protrusion protruding outward in the front-rear direction. The second contact 70 includes a curved portion 72 that is shaped like the letter U. The curved portion 72 protrudes upward from the mount portion 71. The second contact 70 includes a pair of contact points 73 that are formed on respective outside surfaces of the second contact 70, the outside surfaces facing outward in the front-rear direction and being positioned respectively at the front side and at the rear side of the curved portion 72.

Each second contact 70 is formed integrally in a corresponding second-contact holding portion 64 of the second insulator 60 using insert molding. A pair of the contact points 73 are disposed respectively at the front surface and the rear surface of each longitudinal wall 62b. The mount portion 71 protrude outward through the bottom plate 61 and further extend outward in the front-rear direction. The tip end of the mount portion 71 is positioned outside the longitudinal wall 62b in the front-rear direction.

Each metal fitting 80 is formed of a thin plate of an arbitrary metal so as to have a shape as illustrated using progressive metal forming (stamping). The method of manufacturing the metal fitting 80 includes a step of punching out a piece and a step of bending the punched piece in the thickness direction.

The metal fitting 80 includes a base portion 81 shaped tabularly. The metal fitting 80 includes a first extension portion 82 that extends outward from the outside edge of base portion 81 in the right-left direction. The first extension portion 82 is shaped like the letter L. The metal fitting 80 includes second extension portions 83 that extend outward respectively from both ends of base portion 81 in the front-rear direction. Each second extension portion 83 is shaped like the letter L. The metal fitting 80 includes contact points 84 that are formed at respective outside surfaces of the second extension portions 83 in the front-rear direction. The metal fitting 80 includes mount portions 85 positioned at respective bottom ends of the first extension portion 82 and the second extension portions 83. The metal fitting 80 is formed integrally in each metal-fitting holding portion 65 of the second insulator 60 using insert molding.

In the second connector 50 with the above-described structure, the mount portions 71 of respective second contacts 70 are soldered to the mount surface of the circuit substrate CB2 on which a circuit pattern is formed. The mount portions 85 of respective metal fittings 80 are soldered to the mount surface having the circuit pattern. Thus, the second connector 50 is mounted on the circuit substrate CB2. For example, electronic components other than the second connector 50, such as a communication module, are also mounted on the mount surface of the circuit substrate CB2.

The following description focuses on the structure of the connector 1 in the engagement state in which the first connector 10 and the second connector 50 are connected together and the first insulator 20 and the second insulator 60 connect each other with reference to FIGS. 8 to 10. FIG. 8 is a cross-sectional view of the connector 1 taken along line VIII-VIII in FIG. 1.

For example, the orientation of the second connector 50 illustrated in FIG. 7 is first reversed upside down. In this state, the second connector 50 is positioned so as to oppose the first connector 10 while the first connector 10 and the second connector 50 are substantially aligned with each other in the front-rear direction and in the right-left direction. Subsequently, the second connector 50 is lowered. The second connector 50 and the first connector 10 are thereby connected to each other, in other words, the connector 1 is in the connection state. Here, the protrusion 22 of the first insulator 20 connects the recess 63 of the second insulator 60.

In the engagement state, the elastic contact point 35 of each first contact 30 comes into contact with a corresponding contact point 73 of each second contact 70, and the elastic contact arm 34 having spring-like elasticity is elastically deformed inward in the front-rear direction. In the engagement state, the contact point 36 of the first contact 30 comes into contact with the other contact point 73 of the second contact 70. The first contact 30 comes into contact with the second contact 70 at two positions in the front-rear direction, in other words, between the elastic contact point 35 and one of the contact points 73 and between the contact point 36 and the other contact point 73.

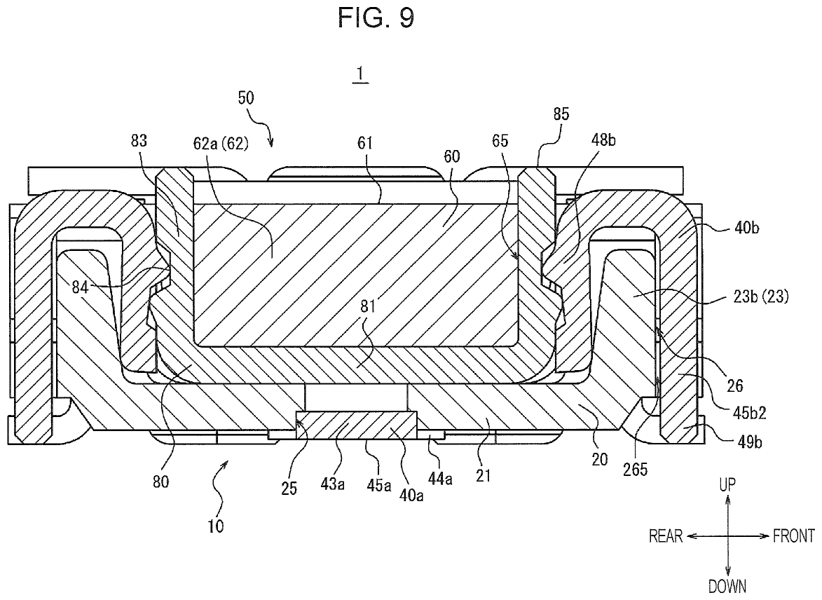

FIG. 9 is a cross-sectional view of the connector 1 taken along line IX-IX in FIG. 1.

In the engagement state, the contact arms 48b of each second metal fitting 40b come into contact with the corresponding contact points 84 of each metal fitting 80. Here, the contact arms 48b having spring-like elasticity are deformed elastically outward in the front-rear direction. The second metal fitting 40b and the metal fitting 80 come into contact with each other at two points in the front-rear direction using the contact arms 48b and the contact points 84.

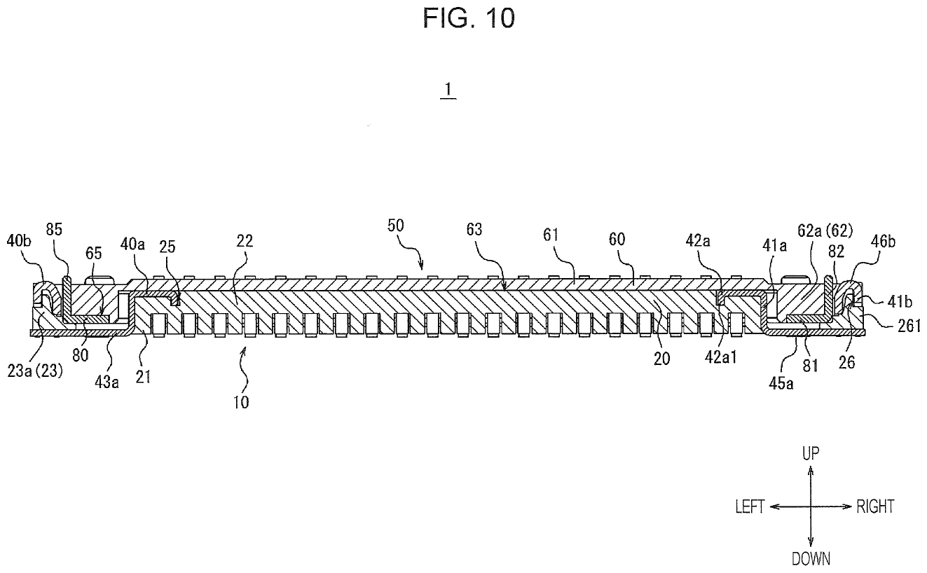

FIG. 10 is a cross-sectional view of the connector 1 taken along line X-X in FIG. 1.

In the engagement state, the second base portion 43a of each first metal fitting 40a is disposed so as to oppose the base portion 81 of the corresponding metal fitting 80 in the up-down direction. In the engagement state, the curved portion 46b of each second metal fitting 40b is disposed so as to oppose the first extension portion 82 of the metal fitting 80 in the right-left direction.

Multiple first contacts 30 are arranged in a row in the arrangement direction, which is parallel to the longitudinal direction of the first connector 10, and each first metal fitting 40a superposes a one first contact 30 positioned at each end of the row in the arrangement direction. For example, as illustrated in FIG. 5, the hook portion 42a of the first metal fitting 40a superposes the one first contact 30 positioned at the end in the arrangement direction. For example, a portion of the hook portion 42a that extends in the right-left direction comes to the same position of the one first contact 30 in the right-left direction.

As illustrated in FIG. 10, the tip end 42a1 of the hook portion 42a of the first metal fitting 40a is positioned, in the arrangement direction, between the one first contact 30 and another first contact 30 disposed next to the one first contact 30. For example, a portion of the hook portion 42a extending in the right-left direction is also positioned, together with the tip end 42a1 that extends in the up-down direction, between the one first contact 30 and another first contact 30 positioned next to the one first contact 30 in the arrangement direction.

The connector 1 according to the embodiment as described above improves in robustness during and after the engagement of the first connector 10 and the second connector 50 even in the case of the connector 1 being reduced in size and height. In the first connector 10, each first metal fitting 40a attached to the protrusion 22 and the corresponding second metal fitting 40b attached to an outside wall 23 are separate members. This reduces an impact caused due to the second connector 50 hitting a metal fitting during engagement compared with a known art in which the metal fitting is formed as one piece. If, for example, the second connector 50 hits a portion of the metal fitting at the protrusion 22 or at the outside wall 23, the connector 1 reduces the likelihood of the impact extending to other portions of the metal fitting. This reduces the likelihood of breakage of the metal fitting & pulled of the first metal fitting 40a and the second metal fitting 40b. The reduction of the likelihood of breakage of the metal fitting reduces the likelihood of breakage of the first insulator 20 to which the metal fitting is attached. This improves the product reliability of the connector 1.

Assume that the first connector 10 and the second connector 50 connect each other in a misaligned state and that during the engagement, the second connector 50 comes into contact with a second metal fitting 40b on the outside wall 23 and causes the second metal fitting 40b and the outside wall 23 to deform and incline outward in the right-left direction. Even in this case, the likelihood of the impact extending to the protrusion 22 is reduced. The deformation of the first metal fitting 40a can be reduced since the first metal fitting 40a and the second metal fitting 40b are separate members. Assume that the second connector 50 comes into contact with a first metal fitting 40a at the protrusion 22 during engagement and causes the first metal fitting 40a and the protrusion 22 to deform inward into the protrusion 22 in the right-left direction. Even in this case, the likelihood of the impact extending to the outside wall 23 is reduced. The likelihood of deformation of the second metal fitting 40b can be reduced since the first metal fitting 40a and the second metal fitting 40b are separate members. Each metal fitting behaves differently and independently at the protrusion 22 and at the outside wall 23. The behavior of the metal fitting at the protrusion 22 does not readily propagate to the metal fitting at the outside wall 23, and vice versa. This reduces the likelihood of the breakage, and the metal fittings as a whole can perform an expected function reliably.

The reduction of the likelihood of breakage of the metal fittings and the first insulator 20 reduces the likelihood of displacement of the first connector 10 and the second connector 50 relative to each other in the contact arrangement direction, in other words, in the longitudinal direction of the first connector 10, during and after the engagement. As a result, electrical continuity between the first contacts 30 and the corresponding second contacts 70 can be achieved exactly as specified in design. The likelihood of the connector 1 loosening can be reduced after the engagement. Positioning function of the first connector 10 and the second connector 50 relative to each other can be maintained. The first connector 10 and the second connector 50 do not come off easily from each other, which improves the product reliability of the connector 1.

In the first connector 10, each first metal fitting 40a includes the mount portion 45a to be mounted on the circuit substrate CB1, which improves the robustness of the first metal fitting 40a. This reduces the deformation of the first metal fitting 40a even when a load is applied thereto. As a result, dimensional accuracy and shape integrity of the first connector 10 can be maintained during the engagement. This improves, for example, the robustness of the protrusion 22 to which the first metal fitting 40a is attached. This can reduce the likelihood of breakage or deformation of the protrusion 22 and can reduce the likelihood of the first connector 10 loosening or being displaced in the longitudinal direction.

The mount portion 45a of the first metal fitting 40a is formed at a position outside of, and adjacent to, the protrusion 22. In other words, the mount portion 45a is present at a position obliquely below a portion subjected to an external force, such as, for example, the curved portion of the first base portion 41a, the curved portion being integrally joined to the end portion of the protrusion 22. Accordingly, the mount portion 45a effectively receives the external force acting on the first metal fitting 40a. This further improves the robustness of the first metal fitting 40a and the protrusion 22.

The mount portion 45a includes the bottom surface of the second base portion 43a. The second base portion 43a extends in the longitudinal direction of the first connector 10, and the bottom surface faces the circuit substrate CB1. Accordingly, the mount portion 45a can receive the external force acting on the first metal fitting 40a. The mount portion 45a is mounted on the circuit substrate CB1, and the first metal fitting 40a is thereby fixed to the circuit substrate CB1. As a result, in spite of an external force acting on the first metal fitting 40a, the mount portion 45a can absorb the resulted impact. This improves the robustness of the first metal fitting 40a extending in the longitudinal direction of the first connector 10. This further improves the robustness of the protrusion 22 extending along the longitudinal direction of the first connector 10.

The first metal fitting 40a superposes a one first contact 30 positioned at each end of the row of the first contacts 30 in the arrangement direction, which can reduce the length of the first connector 10 in the longitudinal direction. This can reduce the longitudinal length of the connector 1 and contributes to the overall size reduction of the connector 1. Moreover, this improves the strength of the connector 1 against external force.

The tip end 42a1 of the hook portion 42a of the first metal fitting 40a is positioned between the one first contact 30 and another first contact 30 in the arrangement direction. As a result, an arbitrarily shaped tip end structure of the hook portion 42a is positioned where a first-contact mounting groove 24 is not formed and the first insulator 20 has a larger thickness. This increases the holding strength of the tip end 42a1 of the hook portion 42a held by the first insulator 20. This increases the holding strength of the first metal fitting 40a held by the first insulator 20. In addition, the arbitrarily shaped tip end structure of the hook portion 42a is positioned where the first insulator 20 has a larger thickness. This reduces the likelihood of stiffness reduction of the protrusion 22 of the first insulator 20 compared with the case in which the tip end structure of the hook portion 42a is positioned where the first-contact mounting groove 24 is formed.

The hook portion 42a is shaped like the letter L, and the tip end 42a1 of the hook portion 42a is embedded in the protrusion 22, which reduces the likelihood of the hook portion 42a being turned up. This increases the holding strength of the hook portion 42a held by the first insulator 20. This increases the holding strength of the first metal fitting 40a held by the first insulator 20.

The first metal fitting 40a is formed of the hook portion 42a, the first base portion 41a, and the second base portion 43a so as to form the crank-like shape integrally as a whole. Accordingly, the entire first metal fitting 40a follows the shapes of the end portion of the protrusion 22 and the bottom plate 21 and integrally fits the first insulator 20. This increases the holding strength of the first metal fitting 40a held by the first insulator 20.

The width of the hook portion 42a in the transverse direction of the first connector 10 is smaller than the width of any other portion of the first metal fitting 40a. This increases the thickness of the first insulator 20 where the hook portion 42a is integrated with the first insulator 20. For example, even if the hook portion 42a superposes the one first contact 30 positioned at the end in the arrangement direction, or even if the first-contact mounting groove 24 is formed at a position corresponding to the hook portion 42a in the arrangement direction, the strength of the first insulator 20 can be maintained due to the hook portion 42a having a narrow width portion. As a result, the robustness of the first connector 10 improves.

The second base portion 43a of each first metal fitting 40a extends in the longitudinal direction of the first connector 10 from the protrusion 22 to the corresponding transverse wall 23a to which a second metal fitting 40b is attached. This improves the robustness of the first metal fitting 40a extending in the longitudinal direction of the first connector 10. This also improves the robustness of the protrusion 22 extending along the longitudinal direction of the first connector 10. The same and/or similar effect can be obtained for the first connector 10 between the protrusion 22 and the corresponding transverse wall 23a that are spaced from each other in the longitudinal direction of the first connector 10. If the second connector 50 hits the metal fitting at the protrusion 22 or at the transverse wall 23a, the connector 1 reduces the likelihood of the impact extending to other portions of the metal fitting.

The mount portion 45a is positioned between the protrusion 22 and the transverse wall 23a. In other words, the mount portion 45a is positioned adjacent to a portion of the first metal fitting 40a on which an external force is likely to act. For example, the mount portion 45a is positioned obliquely below the curved portion of the first base portion 41a, the curved portion being integrally joined to the end portion of the protrusion 22 and subjected to an external force. The mount portion 45a is positioned in the first base portion 41a near or on an imaginary extension line drawn in a direction of an external force from the point on which the external force acts. Accordingly, the mount portion 45a effectively receives the external force acting on the first metal fitting 40a. This further improves the robustness of the first metal fitting 40a and the protrusion 22.

Each second metal fitting 40b has the second mount portions 47b that are disposed in the right-left direction along the inside surface of the corresponding transverse wall 23a, and the second mount portions 47b and the first mount portions 44b are disposed with the transverse wall 23a being interposed therebetween. This improves the robustness of the second metal fitting 40b and the transverse wall 23a in the right-left direction. For example, this reduces the likelihood of the second metal fitting 40b and the transverse wall 23a deforming in the right-left direction. For example, the second metal fitting 40b and the transverse wall 23a do not incline outward easily in the right-left direction during the engagement. The first connector 10 and the second connector 50 may connect each other in a misaligned state. The second connector 50 may hit the second metal fitting 40b on the transverse wall 23a during the engagement. Even in this case, the likelihood of deformation of the second metal fitting 40b and the transverse wall 23a is reduced.

The reduction of the likelihood of deformation of the second metal fitting 40b and the transverse wall 23a reduces the likelihood of displacement of the first connector 10 in the longitudinal direction during and after the engagement of the first connector 10 and the second connector 50. As a result, electrical continuity between the first contacts 30 and the corresponding second contacts 70 can be achieved exactly as specified in design. The likelihood of the connector 1 loosening can be reduced after the engagement. As a result, the dimensional accuracy and the shape integrity of the first connector 10 can be maintained during the engagement. Positioning function of the first connector 10 and the second connector 50 relative to each other can be maintained after the engagement. The first connector 10 and the second connector 50 do not come off easily from each other, which improves the product reliability of the connector 1.

The first mount portions 44b of the second metal fitting 40b are disposed respectively at both sides of the first metal fitting 40a in the transverse direction of the first connector 10. The second mount portions 47b of the second metal fitting 40b are disposed respectively at both sides of the first metal fitting 40a in the transverse direction of the first connector 10. This increases the mounting strength of the second metal fitting 40b mounted on the circuit substrate CB1. This improves the robustness of the second metal fitting 40b and the transverse wall 23a in the right-left direction.

In the front-rear direction, the distance between the first mount portions 44b is larger than the distance between the second mount portions 47b, which increases the mounting strength of the second metal fitting 40b mounted on the circuit substrate CB1. For example, in the front-rear direction, even if the distance between the second mount portions 47b inevitably decreases at the inner side of the transverse wall 23a, the distance between the first mount portions 44b remains to be large. As a result, the mounting strength of the second metal fitting 40b mounted on the circuit substrate CB1 increases. This improves the robustness of the second metal fitting 40b and the transverse wall 23a in the right-left direction.

The first wall portion 261 of which the width is large in the front-rear direction is nipped in the recess of the second metal fitting 40b of which the size is large in the front-rear direction. This increases the holding power of the second-metal-fitting mounting portion 26 in holding the second metal fitting 40b.

A pair of the third mount portions 49b are disposed substantially at the same position as the mount portion 45a in the right-left direction. Accordingly, three mount portions are aligned along an imaginary line extending in the front-rear direction. This increases the mounting strength of the first connector 10 mounted on the circuit substrate CB1. Even if the second connector 50 and the first connector 10 connect each other in a misaligned state in which the second connector 50 is, for example, rotated relative to the first connector 10 at a certain degree about an axis extending in the up-down direction, the first connector 10 remains to be mounted on the circuit substrate CB1. Similarly, even if the circuit substrate CB1 having the connector 1 mounted thereon is rotated, the first connector 10 remains to be mounted on the circuit substrate CB1. Accordingly, the robustness of the first connector 10 mounted on the circuit substrate CB1 improves.

Portions of the second metal fitting 40b are disposed at both sides of the second base portion 43a of the first metal fitting 40a in the transverse direction of the first connector 10, which increases the attaching strength of the second metal fitting 40b attached to the first insulator 20.

The first metal fitting 40a and the first insulator 20 are formed integrally using insert molding, which further improves the robustness of the first metal fitting 40a and the protrusion 22. The first metal fitting 40a includes the wide portion 44a, which increases the contact area between the first metal fitting 40a and the first insulator 20. This increases the holding strength of the first metal fitting 40a integrally held by the first insulator 20 using insert molding. This further improves the robustness of the first metal fitting 40a and the protrusion 22.

Those skilled in the art can obviously implement the present disclosure in a form other than the above-described embodiment without departing from the spirit or the essential features of the present disclosure. As such, the above description is only illustrative and should not be construed as limiting. The scope of the disclosure is not limited by the above description but by the appended claims. Changes that fall within the scope of the claim or the equivalents thereof are to be included in the present disclosure.

For example, the shapes, arrangements, and orientations of elements as well as the number of elements are not limited to what is disclosed in the above description and in the drawings. The shapes, arrangements, and orientations of elements as well as the number of elements may be changed arbitrarily insofar as the specified functions can be implemented.

For example, in the first connector 10, the second metal fittings 40b may be integrated into the first insulator 20 by insert molding rather than by press-fitting. For example, in the first connector 10, the first metal fittings 40a may be attached to the first insulator 20 by press-fitting rather than by insert molding.

In the above description of the embodiment, the mount portion 45a includes the region surrounded by the dash-dot-dot line in FIG. 6, but the mount portion 45a is not limited to this. The mount portion 45a may include an arbitrary region on part of the second base portion 43a. For example, the mount portion 45a may include a region on the second base portion 43a immediately below the corresponding transverse wall 23a. For example, the mount portion 45a may include the entire bottom surface of the second base portion 43a. In this case, in addition to the bottom surface, the mount portion 45a may also include side surfaces of the second base portion 43a, the side surfaces extending in the up-down direction.

In the above description of the embodiment, each first metal fitting 40a superposes the one first contact 30 in the arrangement direction, but the first metal fitting 40a is not limited to this. The first metal fitting 40a need not superpose the one first contact 30 in the arrangement direction if the size reduction of the first connector 10 in the longitudinal direction can be achieved using a different method.

In the above description of the embodiment, the tip end 42a1 of the hook portion 42a of each first metal fitting 40a is positioned between the one first contact 30 and another first contact 30 in the arrangement direction, but the tip end 42a1 is not limited to this. Insofar as the holding strength of the tip end 42a1 of the hook portion 42a held by the first insulator 20 can be maintained, the tip end 42a1 of the hook portion 42a of the first metal fitting 40a may be disposed at the same position, in the right-left direction, as the position of a first contact 30 being attached.

In the above description of the embodiment, the hook portion 42a is shaped like the letter L, and the tip end 42a1 of the hook portion 42a is embedded inside the protrusion 22, but the hook portion 42a is not limited to this. Insofar as the holding strength of the hook portion 42a held by the first insulator 20 can be maintained, the hook portion 42a may have a shape other than the shape like the letter L. In addition, the tip end 42a1 of the hook portion 42a need not be embedded inside the protrusion 22.

In the above description of the embodiment, the width of the hook portion 42a in the transverse direction of the first connector 10 is smaller than the width of any other portion of the first metal fitting 40a, but the width of the hook portion 42a is not limited to this. Insofar as the strength of the first insulator 20 can be maintained, the hook portion 42a may have the same width as that of any other portion of the first metal fitting 40a.

In the above description of the embodiment, the second base portion 43a extends from the protrusion 22 to the corresponding transverse wall 23a to which the second metal fitting 40b is attached, but the second base portion 43a is not limited to this. Insofar as the robustness of the first metal fitting 40a improves in the longitudinal direction of the first connector 10, the second base portion 43a may extend by an arbitrary length from the protrusion 22 toward the transverse wall 23a.

In the above description of the embodiment, the mount portion 45a is positioned between the protrusion 22 and the transverse wall 23a, but the mount portion 45a is not limited to this. The mount portion 45a may be faulted at an arbitrary position of the first metal fitting 40a insofar as the mount portion 45a is positioned adjacent to a portion of the first metal fitting 40a on which an external force is likely to act. For example, the mount portion 45a may be present at the same position, in the right-left direction, as the position of the end of the protrusion 22.

In the above description of the embodiment, each second metal fitting 40b is attached to the corresponding transverse wall 23a, but the second metal fitting 40b is not limited to this. For example, the second metal fitting 40b need not be attached to the transverse wall 23a and may be attached only to the longitudinal walls 23b.

In the above description of the embodiment, the second metal fitting 40b has the second mount portions 47b that are disposed along the inside surface of each transverse wall 23a facing inward in the right-left direction, and the second mount portions 47b and the first mount portions 44b are disposed with the transverse wall 23a being interposed therebetween, but the second metal fitting 40b is not limited to this. The second metal fitting 40b need not include the second mount portions 47b insofar as the robustness of the second metal fitting 40b and the transverse wall 23a can be maintained.

In the above description of the embodiment, the first mount portions 44b of the second metal fitting 40b are disposed respectively at both sides of the first metal fitting 40a in the transverse direction of the first connector 10, and the second mount portions 47b of the second metal fitting 40b are disposed respectively at both sides of the first metal fitting 40a in the transverse direction of the first connector 10, but the first mount portions 44b and the second mount portions 47b are not limited to this. Either of the first mount portions 44b or the second mount portions 47b may be disposed at both sides of the first metal fitting 40a in the transverse direction of the first connector 10. Only one first mount portion 44b or three or more first mount portions 44b may be provided rather than the two first mount portions 44b. Similarly, only one second mount portion 47b or three or more second mount portions 47b may be provided rather than the two second mount portions 47b.

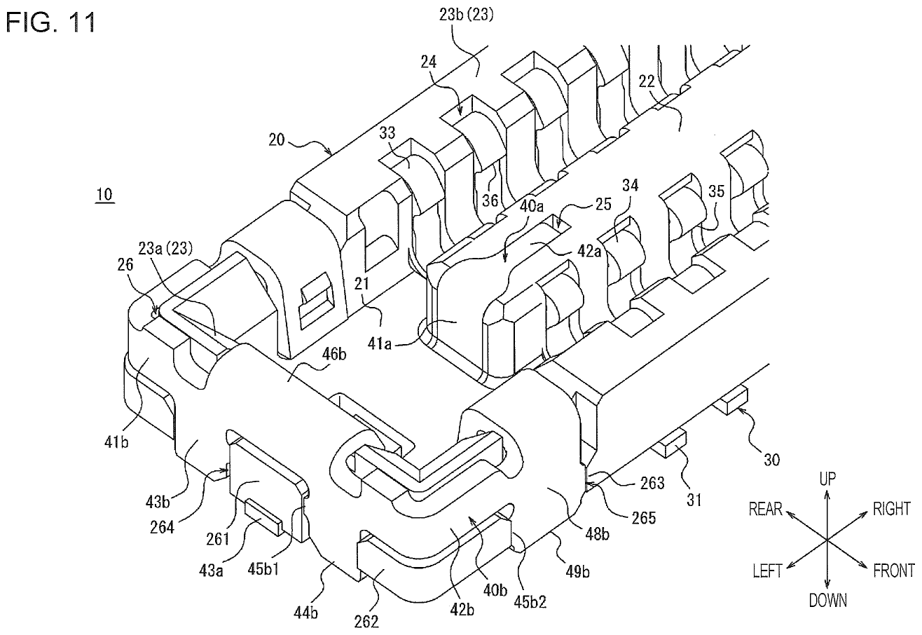

FIG. 11 is an enlarged view illustrating a first variation of the first connector 10 of the embodiment, the view corresponding to FIG. 5. In the above description of the embodiment, part of the top surface of the second base portion 43a is exposed from the first insulator 20 at the position where the second base portion 43a is integrated with the bottom plate 21, but the second base portion 43a is not limited to this. As illustrated in FIG. 11, the top surface of the second base portion 43a may be covered by the first insulator 20. This increases the holding strength of the first metal fitting 40a held by the first insulator 20 that is fat wed using insert molding. This further improves the robustness of the first metal fitting 40a and the protrusion 22.

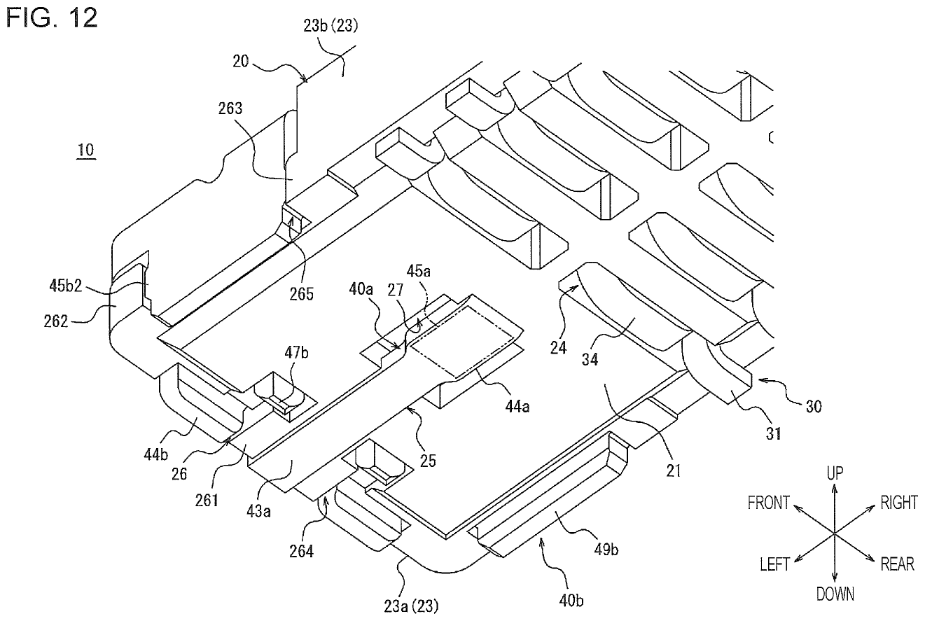

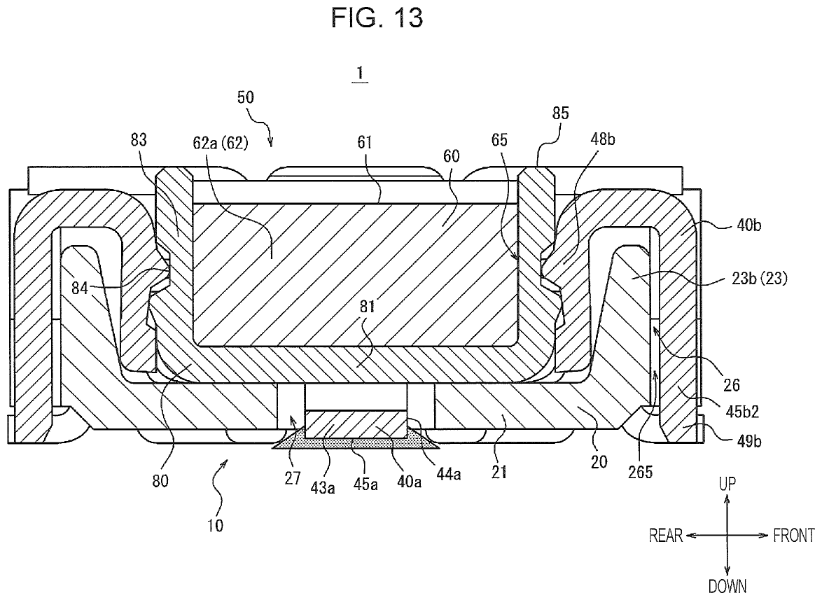

FIG. 12 is an enlarged view illustrating a second variation of the first connector 10 of the embodiment, the view corresponding to FIG. 6. FIG. 13 is a cross-sectional view illustrating the second variation of the first connector 10 of the embodiment, the view corresponding to FIG. 9. In the above description of the embodiment, when each first metal fitting 40a and the first insulator 20 are formed integrally using insert molding, the second base portion 43a with the wide portion 44a is in close contact with the bottom plate 21 as illustrated in FIG. 6, but the first insulator 20 is not limited to this.

For example, the first insulator 20 may include a hole 27 that pierces the bottom plate 21 in the up-down direction in a region where the wide portion 44a is formed. Alternatively, the first insulator 20 may include a recess rather than the hole 27, the recess being formed in the bottom plate 21 in the region where the wide portion 44a is formed.

The mount portion 45a of the first metal fitting 40a to be mounted on the circuit substrate CB1 includes the bottom surface of the second base portion 43a that faces the circuit substrate CB1. For example, the mount portion 45a has a predefined area extending in the front-rear direction and in the right-left direction on the bottom surface of the wide portion 44a. The mount portion 45a also includes the side surfaces of the wide portion 44a extending in the up-down direction.

The mount portion 45a, however, may further include the top surface of the wide portion 44a. For example, as illustrated in FIG. 13, the top surface of the second base portion 43a is positioned below the top surface of the bottom plate 21. Accordingly, even if solder may reach the top surface of the wide portion 44a, the solder can be accommodated in the space between the top surface of the wide portion 44a and the base portion 81 of the metal fitting 80. This reduces the likelihood of engagement failure between the first connector 10 and the second connector 50. In other words, this reduces the likelihood of an excessive amount of soler interfering the engagement between the first connector 10 and the second connector 50.

The mount portion 45a is positioned between the protrusion 22 and the transverse wall 23a in the right-left direction. The mount portion 45a is foliated at a position outside of, and adjacent to, the protrusion 22 in the right-left direction.

The mount portion 45a that is formed widely increases the mounting strength of the first connector 10 mounted on the circuit substrate CB1. In addition, the first insulator 20 includes the hole 27, which enables side fillets of solder to be formed, for example, as illustrated in FIG. 13. This increases the mounting strength of the first connector 10 mounted on the circuit substrate CB1. As a result, the robustness of the first connector 10 improves.

The second base portion 43a includes the wide portion 44a at a position superposing the hole 27 in the right-left direction. The second base portion 43a also includes a portion that extends from the wide portion 44a toward the transverse wall 23a and that is in close contact with the bottom plate 21, and the width of this portion is smaller than the width of the wide portion 44a in the right-left direction. Accordingly, the thickness of the bottom plate 21 increases where the second base portion 43a is integrated with the bottom plate 21. This increases the strength of the first insulator 20. As a result, the robustness of the first connector 10 improves.

The above-described connector 1 consisting of the first connector 10 and the second connector 50 is used in an electronic apparatus that includes the circuit substrate CB1 and the circuit substrate CB2. For example, the type of electronic apparatus may be any communication terminal equipment, such as a smartphone, and any information processing equipment, such as a personal computer, a copier, a printer, a facsimile, or a multifunction printer. For example, the type of electronic apparatus may be any onboard equipment, such as a camera, a radar, a car digital video recorder, or an engine control unit. For example, the type of electronic apparatus may be any other onboard equipment to be used in an onboard system, such as a car navigation system, an advanced driver-assistance system, or a security system. Moreover, the type of electronic apparatus may be any arbitrary industrial equipment.

In the above-described electronic apparatus, the robustness of the connector 1 improves during the engagement of the first connector 10 and the second connector 50 even in the case of the connector 1 being reduced in size and height. This improves the product reliability of the electronic apparatus.

### REFERENCE SIGNS

1 connector
10 first connector
20 first insulator (insulator)
21 bottom plate
22 profusion
23 outside wall
23a transverse wall
23b longitudinal wall
24 first-contact mounting groove
25 first-metal-fitting holding portion
26 second-metal-fitting mounting portion
261 first wall portion
262 second wall portion
263 third wall portion
264 first mounting groove
265 second mounting groove
27 hole
30 first contact
31 mount portion
32 locking portion
33 curved portion
34 elastic contact arm
35 elastic contact point
36 contact point
40a first metal fitting
41a first base portion
42a hook portion
42a1 tip end
43a second base portion
44a wide portion
45a mount portion
40b second metal fitting
41b first base portion
42b second base portion
43b protruding portion
44b first mount portion
45b1 locking portion
45b2 locking portion
46b curved portion
47b second mount portion
48b contact am′
49b third mount portion
50 second connector
60 second insulator
61 bottom plate
62 outside wall
62a transverse wall
62b longitudinal wall
63 recess
64 second-contact holding portion
65 metal-fitting holding portion
70 second contact
71 mount portion
72 curved portion
73 contact point
80 metal fitting
81 base portion
82 first extension portion
83 second extension portion
84 contact point
85 mount portion
CB1 circuit substrate
CB2 circuit substrate

1. A connector comprising:
a first connector and a second connector to connect each other,
wherein the first connector comprises:
an insulator comprising a protrusion and an outside wall surrounding the protrusion;
a first metal fitting comprising a second base portion extending in a longitudinal direction of the first connector and a mount portion to be mounted onto a circuit substrate, the first metal fitting being attached to the protrusion; and
a second metal fitting being attached to the outside wall,
wherein the first metal fitting and the second metal fitting are separate members, and
wherein the mount portion includes a bottom surface of the second base portion, the bottom surface facing the circuit substrate.

2. The connector according to claim 1,
wherein the first connector comprises multiple contacts arranged in a row extending in an arrangement direction being parallel to the longitudinal direction of the first connector, and
wherein in the arrangement direction, the first metal fitting superposes one of the contacts positioned at an end of the row.

3. The connector according to claim 2,
wherein the first metal fitting comprises a hook portion with a tip end, the tip end being positioned between the one of the contacts and a contact adjacent to the one of the contacts in the arrangement direction.

4. The connector according to claim 3,
wherein the first metal fitting comprises a first base portion shaped like a letter L, the first base portion connecting the second base portion and the hook portion, and
wherein the hook portion, the first base portion, and the second base portion are formed integrally and have a crank-like shape.

5. The connector according to claim 3,
wherein in a transverse direction of the first connector that orthogonally intersects the arrangement direction, a width of the hook portion is smaller than a width of any other portion of the first metal fitting.

6. The connector according to claim 1,
wherein the outside wall comprises a longitudinal wall and a transverse wall, and
wherein the second base portion extends from the protrusion to the transverse wall to which the second metal fitting is attached.

7. The connector according to claim 6,
wherein the mount portion is positioned between the protrusion and the transverse wall.

8. The connector according to claim 6,
wherein the second metal fitting comprises:
first mount portions disposed along an outside surface of the transverse wall, the outside surface facing outward in the longitudinal direction; and
second mount portions disposed along an inside surface of the transverse wall, the inside surface facing inward in the longitudinal direction, and
wherein the first mount portion and the second mount portion straddle the transverse wall.

9. The connector according to claim 8,
wherein at least either of the first mount portions of the second metal fitting and the second mount portions of the second metal fitting are disposed respectively at both sides of the first metal fitting in the transverse direction of the first connector.

10. The connector according to claim 1,
wherein portions of the second metal fitting are disposed respectively at both sides of the second base portion of the first metal fitting in the transverse direction of the first connector.

11. The connector according to claim 1,
wherein the first metal fitting and the insulator are integrally formed using insert molding.

12. An electronic apparatus comprising the connector according to claim 1.

13. The connector according to claim 2,
wherein the outside wall comprises a longitudinal wall and a transverse wall, and
wherein the second base portion extends from the protrusion to the transverse wall to which the second metal fitting is attached.

14. The connector according to claim 3,
wherein the outside wall comprises a longitudinal wall and a transverse wall, and
wherein the second base portion extends from the protrusion to the transverse wall to which the second metal fitting is attached.

15. The connector according to claim 7,
wherein the second metal fitting comprises:
first mount portions disposed along an outside surface of the transverse wall, the outside surface facing outward in the longitudinal direction; and
second mount portions disposed along an inside surface of the transverse wall, the inside surface facing inward in the longitudinal direction, and
wherein the first mount portion and the second mount portion straddle the transverse wall.

16. The connector according to claim 2,
wherein portions of the second metal fitting are disposed respectively at both sides of the second base portion of the first metal fitting in the transverse direction of the first connector.

17. The connector according to claim 3,
wherein portions of the second metal fitting are disposed respectively at both sides of the second base portion of the first metal fitting in the transverse direction of the first connector.

18. The connector according to claim 6,
wherein portions of the second metal fitting are disposed respectively at both sides of the second base portion of the first metal fitting in the transverse direction of the first connector.

19. The connector according to claim 7,
wherein portions of the second metal fitting are disposed respectively at both sides of the second base portion of the first metal fitting in the transverse direction of the first connector.
